(19) United States
(12) Patent Application Publication
(10) Pub. No.: US 2007/0299983 A1
(43) Pub. Date: Dec. 27, 2007

(54) Apparatus for synchronizing multicast audio and video

(76) Inventor: Thomas Jeff Brothers, Gainesville, GA (US)

Correspondence Address: SCOTT P. ZIMMERMAN, PLLC, PO BOX 3822, CARY, NC, 27519, US

(21) Appl. No.: 11/810,811

(22) Filed: Jun. 7, 2007

Related U.S. Application Data
(60) Provisional application No. 60/815,405, filed on Jun. 21, 2006.

(51) Int. Cl. G06F 15/16; G06F 17/00

(52) U.S. Cl. 709/231; 715/500.1; 709/246

(57) ABSTRACT

A multicast data stream synchronizer includes a video decoder for deciphering and decoding a video stream, an audio decoder for deciphering and decoding an audio stream matching an audio presentation profile, a video buffer, an audio buffer, and an AV synchronizer to generate a synchronized frame of audio video data. According to the exemplary embodiments, the audio presentation profile comprises a selected audio format and a selected language preference such that undesirable audio formats and undesirable languages are filtered from the audio stream to conserve bandwidth. Still further, the AV synchronizer itself may present the synchronized frame, or alternatively, the AV synchronizer may communicate the synchronized frame to a multimedia device.

### CROSS REFERENCE TO RELATED APPLICATIONS

This application claims the benefit of co-pending U.S. Provisional Application No. 60/815,405 filed on Jun. 21, 2006, and of which is incorporated herein by reference in its entirety.

This application relates to a commonly assigned co-pending application entitled “Systems and Methods for Multicasting Audio” (Attorney Docket No. BLS060184) filed simultaneously herewith, and of which is incorporated herein by this reference in its entirety.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### BACKGROUND

The exemplary embodiments generally relate to communications and, more particularly, to apparatus for synchronizing multicast audio and video data streams.

Bandwidth is becoming a problem in the communications industry. As subscribers demand more and more content, higher definition services, interactive services, and data services, the existing network infrastructure has trouble supplying adequate bandwidth. The industry is hard at work identifying new ways of increasing bandwidth. The industry is also striving to reduce wasted bandwidth.

Because audio streaming accounts for approximately 10% of the bandwidth that video streaming uses, little consideration has been directed to handling audio applications. However, opportunities exist for reducing bandwidth consumption of audio content. For example, whenever an audio-video (AV) stream is sent to a multimedia device, all of the audio formats for the audio content are also sent with the video. That is, for example, the content provider may send DOLBY® 5.1 as the primary audio format (e.g., English) as well as send two secondary audio programs for alternate languages (e.g., Spanish and French). Consequently, all three audio streams are sent with the video stream to the multimedia device, even though only one audio stream is presented with the video stream. This consumption then increases bandwidth consumption of the subscriber and also reduces efficiency of the communications network.

### SUMMARY

The exemplary embodiments address the above needs and other needs by providing a multicast data stream synchronizer that includes a video decoder for deciphering and decoding a video stream, an audio decoder for deciphering and decoding an audio stream matching an audio presentation profile, a video buffer, an audio buffer, and synchronization means to generate a synchronized frame of audio video data. According to the exemplary embodiments, the audio presentation profile comprises a selected audio format and a selected language preference such that undesirable audio formats and undesirable languages are filtered from the audio stream to conserve bandwidth. Still further, the synchronizer itself may present the synchronized frame, or alternatively, the synchronizer may communicate the synchronized frame to a multimedia presentation device.

The multicast distribution network may be used for video-on-demand and/or multicast audio and/or video access control. According to an exemplary embodiment, user signaling at the application layer for the media service is Session Internet Protocol (SIP). The Session Initiation Protocol (SIP) is an Internet Engineering Task Force (IETF) standard protocol for initiating an interactive user session that involves multimedia elements such as video, voice, chat, gaming, and virtual reality. SIP works in the Application layer of the Open Systems Interconnection (OSI) communications model. The Application layer is the level responsible for ensuring that communication is possible. SIP can establish multimedia sessions or Internet telephony calls, and modify, or terminate them. The protocol can also invite participants to unicast or multicast sessions that do not necessarily involve the initiator. Because the SIP supports name mapping and redirection services, SIP makes it possible for a user to initiate and receive communications and services from any location and for networks to identify the user regardless of the user's location.

According to the exemplary embodiment, the application layer uses SIP, the network is aware of this, and the network accordingly adjusts. Where communications and/or computing devices proxy messages forward, the equipment in the network is aware of the SIP transactions. The network equipment then makes the necessary changes in the network in response to the SIP transactions. The SIP is used as a networking layer protocol between end points to a session (e.g., the synchronizer, a multimedia presentation device such as a customer's computer or a set-top box, a content source, and others). The SIPs can accept a wide range of media types including multicast IP addresses and Uniform Resource Locators (URLs) to define the location of the media stream including video streams, audio streams, integrated AV streams, and data streams. The requesting end point to the media session can be used for media display services such as Television over Internet Protocol (TVOIP) as well as participating in bi-directional media services (e.g., multimedia conferencing).

The exemplary embodiments also utilize URLs. The use of URLs permits the use of a Domain Name Server (DNS) system to provide translation between the URL name and the network address of the media. This permits a common name space to include multicast and unicast unidirectional media as well as bidirectional services such as multimedia conferencing. The DNS system may be localized to a network of a service provider (e.g., AT&T), or published to the public internet.

Other systems, methods, and/or computer program products according to embodiments will be or become apparent to one with skill in the art upon review of the following drawings and detailed description. It is intended that all such additional systems, methods, and/or computer program products be included within and protected by this description and be within the scope of the present invention.

### DESCRIPTION OF THE DRAWINGS

The above and other embodiments, objects, uses, advantages, and novel features are more clearly understood by reference to the following description taken in connection with the accompanying figures, wherein:

FIG. 1 illustrates an operating environment for multicast data streaming according to some of the exemplary embodiments;

FIGS. 2 and 3 illustrate exemplary multicast media sessions according to some of the exemplary embodiments;

FIG. 4 illustrates another operating environment for multicast data streaming according to some of the exemplary embodiments;

FIG. 5 illustrates a block diagram of an exemplary apparatus for synchronizing multicast data streams according to some of the embodiments;

FIG. 6 illustrates a block diagram of an exemplary multimedia presentation device integrated with the synchronizer of FIG. 5 according to some of embodiments;

FIG. 7 illustrates yet another operating environment for multicast data streaming according to some of the exemplary embodiments;

FIG. 8 illustrates another exemplary multicast media session according to some of the exemplary embodiments; and

FIG. 9 illustrates a flow chart for synchronizing audio data and video data according to some of the embodiments.

### DESCRIPTION

This invention now will be described more fully hereinafter with reference to the accompanying drawings, in which exemplary embodiments are shown. This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (ie., any elements developed that perform the same function, regardless of structure).

Thus, for example, it will be appreciated by those of ordinary skill in the art that the diagrams, flowcharts, illustrations, and the like represent conceptual views or processes illustrating systems, methods and computer program products embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named manufacturer.

Exemplary embodiments describe methods, systems, and devices that conserve bandwidth in a communications network. These exemplary embodiments describe how to reduce the occurrences of wasted bandwidth within a communications network to a multimedia device of an end user (e.g., a content service provider's communication of a media stream having an English DOLBY® 5.1 audio format and corresponding video program to an Internet Protocol television of a subscriber or user). As used herein, the terms “end user,” “subscriber,” “customer,” and “individual” are used to describe one or more persons that may actively (e.g., by entering commands into the multimedia device to request a selected audio format) or passively interact with the multimedia device. The exemplary embodiments identify a desired audio format of an individual using the multimedia device. For example, if the individual prefers an English audio presentation, then the exemplary embodiments filter the audio content for the English format and communicate the reduced bandwidth media stream. Some of the exemplary embodiments, consequently, filter out undesired audio formats to degrade the media stream, and thus, conserve bandwidth in the network.

Exemplary embodiments are directed at a multicast data stream synchronizer that includes a video decoder for deciphering and decoding a video stream, an audio decoder for deciphering and decoding an audio stream matching an audio presentation profile, a video buffer, an audio buffer, and a synchronizer that generates a synchronized frame of audio video data. According to the exemplary embodiments, the audio presentation profile comprises a selected audio format and a selected language preference such that undesirable audio formats and undesirable languages are filtered from the audio stream to conserve bandwidth. Still further, the synchronizer itself may present the synchronized frame, or alternatively, the synchronizer may communicate the synchronized frame to a multimedia presentation device.

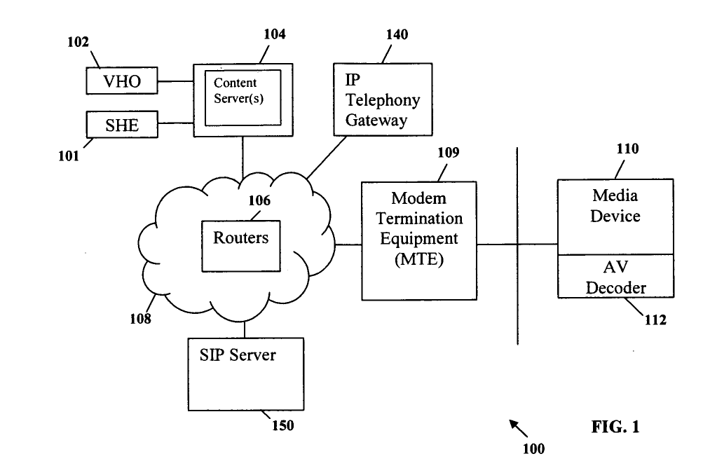

FIG. 1 illustrates an operating environment 100 for some of the exemplary embodiments. FIG. 1 illustrates a communications network 108. The communications network 108 may be a cable network operating in the radio-frequency domain and/or the Internet Protocol (IP) domain. The communications network 108, however, may also include a multicast distribution network, such as the Internet (sometimes alternatively known as the “World Wide Web”), an intranet, a local-area network (LAN), and/or a wide-area network (WAN). The communications network 108 may include coaxial cables, copper wires, fiber optic lines, and/or hybrid-coaxial lines. The communications network 108 may even include wireless portions utilizing any portion of the electromagnetic spectrum and any signaling standard (such as the I.E.E.E. 802 family of standards). According to an exemplary embodiment, a multimedia device 110 resides in an IP address space of a customer's/subscriber's residence or a business network. The multimedia device 110 may be any communications device capable of sending and receiving Session Internet Protocol (SIP) signaling and/or other signaling, such as Internet Group Multicast Protocol and others. The Session Initiation Protocol (SIP) is an Internet Engineering Task Force (IETF) standard protocol for initiating an interactive user session that involves multimedia elements such as video, voice, chat, gaming, and virtual reality. SIP works in the Application layer of the Open Systems Interconnection (OSI) communications model. The Application layer is the level responsible for ensuring that communication is possible. SIP can establish multimedia sessions or Internet telephony calls, and modify, or terminate them. The protocol can also invite participants to unicast or multicast sessions that do not necessarily involve the initiator. Because the SIP supports name mapping and redirection services, SIP makes it possible for a user to initiate and receive communications and services from any location and for networks to identify the user regardless of the user's location.

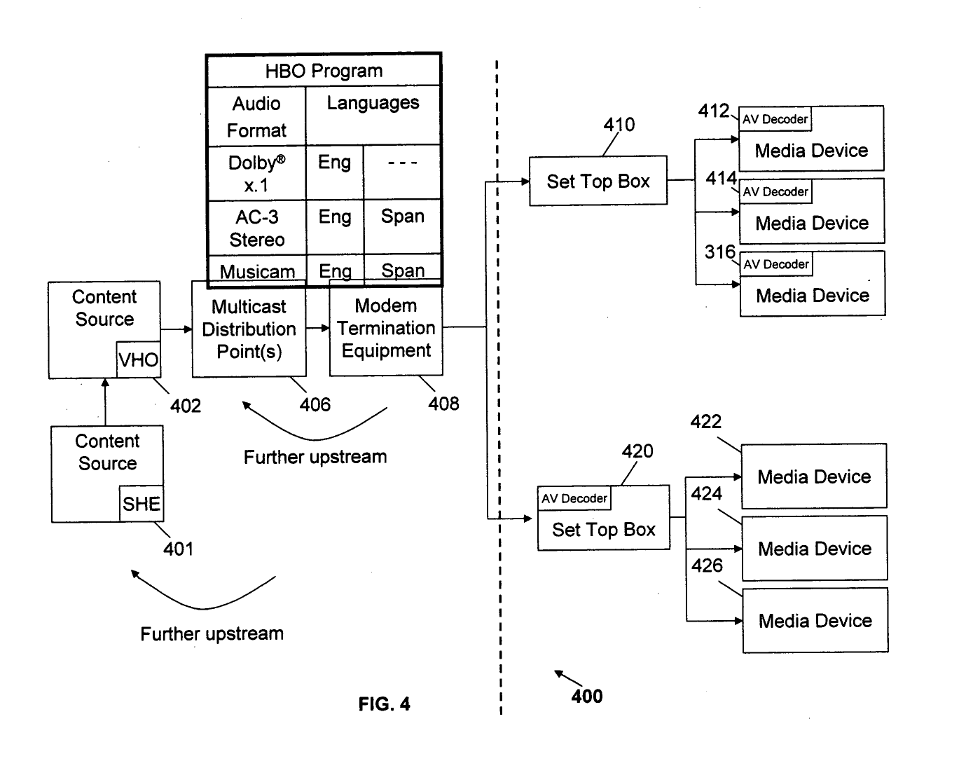

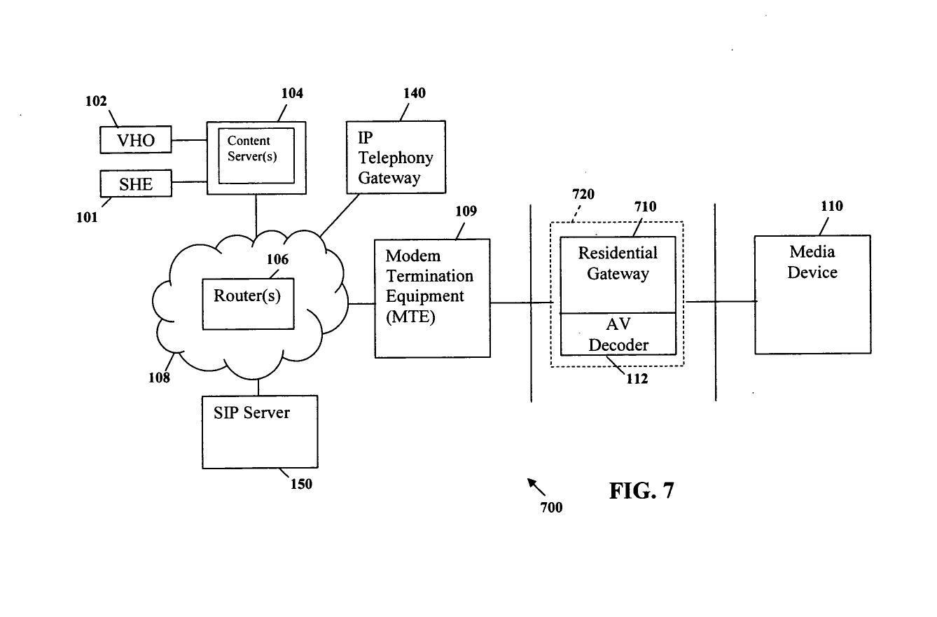

In exemplary embodiments, the multimedia device 110, for example, may comprise a set-top box (shown as reference numerals 410 and 420 of FIG. 4), a personal digital assistant (PDA), a location and positioning devices, such as a Global Positioning System (GPS) device, an interactive television, an Internet Protocol (IP) phone, a pager, a cellular/satellite phone, or any computer system and/or communications device utilizing a digital signal processor (DSP). The multimedia device 110 may also comprise a wearable device (e.g., a watch), radio, vehicle electronics, clock, printer, gateway, and/or another apparatus and system. In further exemplary embodiments, the multimedia device 110 may communicate with a residential gateway (shown as reference numeral 710 in FIG. 7) that provides access to modem termination equipment (MTE) 109.

The multimedia device 110 communicates with the communications network 108 via the MTE 109, such as a Digital Subscriber Line Access Multiplexers (DSLAM), a Cable Modem Termination System (CMTS) (not shown), and/or other modem termination devices for routing/switching content to the multimedia device 110. Various routers 106 of the communications network 108 communicate within the communications network 108 to route requests, queries, proxies, signaling, messages, and/or data between one or more content sources 104, such as a Video Head End Office (VHO) 102 and/or a Super Head End (SHE) 101, an IP telephony gateway 140, and/or an SIP server 150. According to exemplary embodiments, the SHE 101 may be used as a backup and video depot for the VHO 102; thus, the VHO 102 typically contains a subset of the content and is smaller in architecture than the SHE 101.

The requested media stream(s) is then communicated to the multimedia device(s) 110 and decoded and deciphered by at least one AV Decoders 112 that operates with the multimedia devices 110 to provide the audio video synchronizer tools and synchronize the audio video frame for presentation via the multimedia devices 110. For example, the multimedia device 110 may request the media stream having an English DOLBY® 5.1 audio format. The communications network 108 communicates a video stream and a selected audio stream having the requested format to the multimedia device 110. Thereafter, at least one AV decoder 112 detects and decodes the media stream(s) and synchronizes the video stream and audio stream for synchronized presentation to the multimedia device 110. The AV decoder 112 includes components that decode, decipher, and/or synthesize various audio and/or video formats, codecs, and/or ancillary standards, such as, Moving Picture Experts Group (MPEG) standards including H.263 and H.264, Society of Motion Picture and Television Engineers (SMPTE) standards including VC-1, ITU Telecommunications Standards (ITU-T), and others.

The customer/subscriber initiates a media session at the multimedia device 110, such as by selecting an item from a menu, by clicking on a remote control, by voice commands, and/or by other selection methods as known by one of ordinary skill in the art. The multimedia device 110 initiates the media session with a media request communicated towards the communications network 108. The routers 106 interpret the media request and initiate the media session with the appropriate elements. This may involve a variety of actions such as SIP redirection to the IP telephony specific SIP based system, proxy functions for authentication and authorization aspects, establishing unidirectional media flows from the content source 104, and/or establishing or joining multicast flows in the communications network 108. Further, the use of a common session initiation protocol may provide a common mechanism to identify all of the sessions that require admission control decisions based on resource constraints, regardless of the type of service involved.

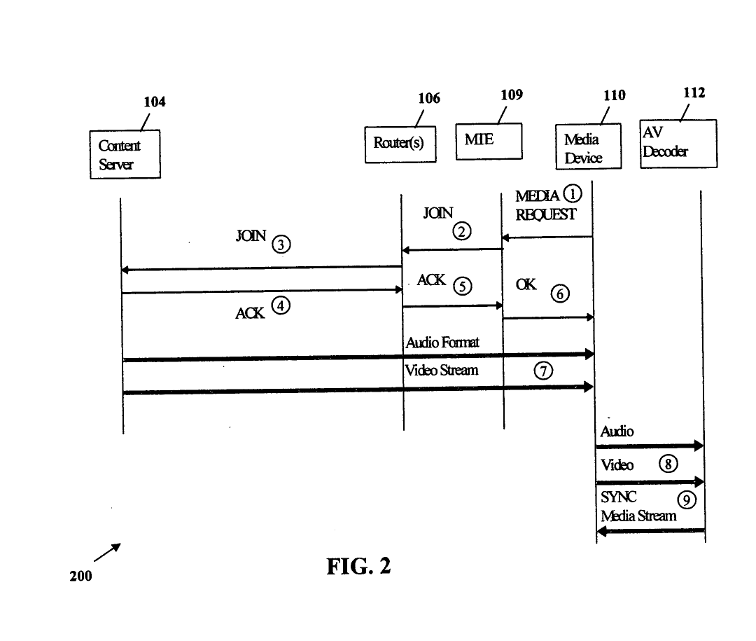

FIG. 2 is a schematic illustrating a multicast media session 200 according to some of the embodiments of this invention. Here the multimedia device 110 knows the source for the multicast media session, and the customer/subscriber is authorized to access this media source. When the customer/subscriber desires a session, the multimedia device communicates the media request to the routers 106 through the communications network (e.g., a multicast distribution network) via the MTE 109. Thereafter, the MTE 109 mechanism generates a command (shown as “JOIN” in the figures) to access the media source, such as, for example, by generating an Internet Group Management Protocol (IGMP) join that is communicated to one or more routers 106. Various routers 106 within the communications network 108 route the IGMP join to an appropriate multicast content source, such as the content source 104. The IGMP may be used symmetrically or asymmetrically, such as asymmetric protocol used between multicast routers 106. Thereafter, the content source 104 responds with an acknowledgement, such as, for example, an IGMP acknowledgement (referred to as “ACK” in the figures) or similar message indicating the command to access the media source looks like a reasonable request and that the content can be supplied. The IGMP acknowledgement is communicated to the routers 106, from the router 106 to the MTE 109. The MTE 109 converts the IGMP acknowledgment to a universal protocol “OK” and forwards the “OK” to the multimedia device 110. The requested multicast media streams then communicate as a video stream and an audio stream (having a selected format) from the appropriate multicast content source 104 to the multimedia device 110. From the message exchange, the multimedia device 110 has sufficient information to identify and associate the requested multicast media streams. Thereafter, at least one AV decoder 112 receives the media streams and synchronizes theses streams for integrated presentation via the multimedia device 110.

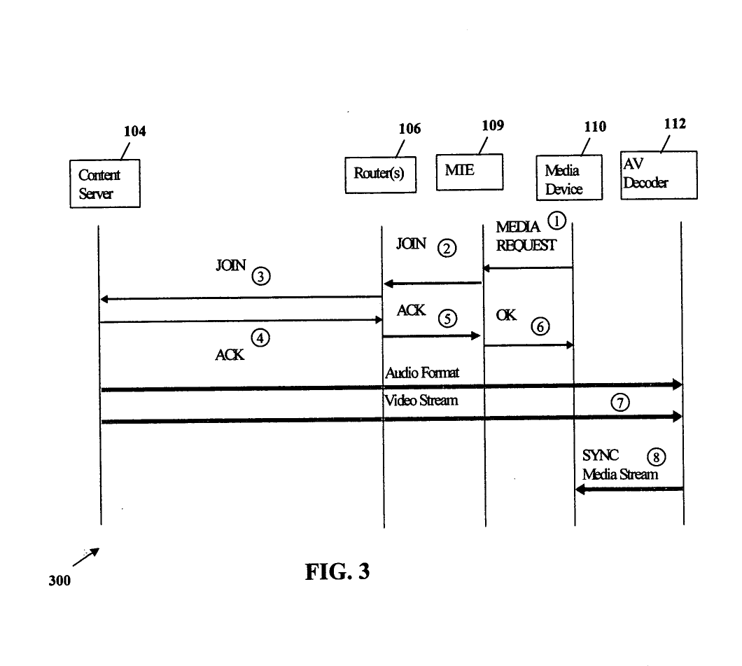

Alternatively, as shown in FIG. 3, the requested multicast media streams may communicate the video stream and the matched audio stream from the appropriate multicast content source 104 directly to the AV decoder 112. Next, the AV decoder 112 detects, decodes, and deciphers these media streams and synchronizes theses streams for integrated presentation. Thereafter, the synchronized audio video stream is communicated to the multimedia device 110 for presentation.

FIG. 4 illustrates another operating environment 400 for multicast data streaming according to some of the exemplary embodiments. The operating environment includes a communications network that may be a cable network operating in the radio-frequency domain and/or the Internet Protocol (IP) domain. The communications network 400, however, may also include the communications network 108.

According to the exemplary embodiment of FIG. 4, one or more multimedia devices 412, 414, 416, 422, 424, and 426 reside in customer's/subscriber's IP address space, such as a customer's/subscriber's residence or a business network. The multimedia devices 412, 414, 416, 422, 424, and 426 may be any communications device capable of sending and receiving communications signals. The multimedia devices 412, 414, 416, 422, 424, and 426 for example, may comprise an integrated set-top box (e.g., integrated multimedia device 412 and set-top box 410), a personal digital assistant (PDA), a location and positioning devices, such as a Global Positioning System (GPS) device, an interactive television, an Internet Protocol (IP) phone, a pager, a cellular/satellite phone, or any computer system and/or communications device utilizing a digital signal processor (DSP). The multimedia devices 412, 414, 416, 422, 424, and 426 may also comprise a wearable device (e.g., a watch), radio, vehicle electronics, clock, printer, gateway, and/or another apparatus and system.

In further exemplary embodiments, the multimedia devices 412, 414, 416, 422, 424, and 426 may communicate with a set top box 410, 420 that provides access to the IP address space via a communications connection with modem termination equipment (MTE) 408, such as a DSLAM or CMTS. The multimedia devices 412, 414, 416, 422, 424, and 426 communicate with the communications network 108 via the MTE 408 or other modem termination equipment for routing/switching to the multimedia devices 412, 414, 416, 422, 424, and 426. Various routers 106 of the communications network 108 communicate within the communications network 108 to upstream multicast distribution points and/or switches to route requests, queries, proxies, signaling, messages, and/or data with one or more content sources, such as VHO source 402 and SHE source 401.

The requested media stream of FIG. 4 comprises a broadcast network program that has multiple audio formats, such as an English, DOLBY® x.1 version, an English AC-3 stereo format, a Spanish AC-3 stereo format, an English Musicam format, and a Spanish Musicam format. According to an exemplary embodiment, the set top box 410 communicates with the multimedia devices 412, 414, and 416 to automatically select one of the available audio formats, receive the media streams having the selected audio format, and interact with an internal AV decoder component of the multimedia device 412, 414, and 416 to present the synchronized AV stream. Alternatively, the user/subscriber may select or be prompted to select an available audio format with the media request. Still, according to further embodiments, the set top box 420 may include instructions to automatically select one of the available audio formats, receive the media streams having the selected audio format, and interact with an internal AV decoder of the set top box to synchronize the AV stream and then present the synchronized AV stream to one or more multimedia devices 422, 424, and 426. For example, set top box 410 may interface with multimedia device 412 to request a media stream having an English DOLBY® 5.1 audio format. The communications network 108 communicates a video stream and a selected audio stream having the requested format to the set top box. Thereafter, the set top box communicates the video stream and the selected audio stream to media device 412 and the AV decoder component of the media device 412 detects and decodes the media streams for synchronized presentation of the video stream and audio stream.

According to an exemplary embodiment, each multimedia device 412, 414, 416 may request different audio formats. For example, multimedia device 412 may request the media stream having a Spanish AC-3 audio format. The communications network 108 communicates a video stream and a selected audio stream having the requested format to the multimedia device 412 via set top box 410. Thereafter, an internal AV decoder of multimedia device 412 detects and decodes the media streams for synchronized presentation. Similarly, multimedia device 414 may request the media stream having an AC-3 Stereo format.

According to another exemplary embodiment, the set top box 420 provides the instructions for selecting the audio presentation of the media stream and all of the coupled multimedia devices 422, 424, and 426 receive the synchronized media stream having the same audio format. For example, set top box 420 may request the media stream having a Spanish AC-3 audio format. The communications network 108 communicates a video stream and a selected audio stream having the requested format to the set top box 420. Thereafter, an internal AV decoder of the set top box 420 detects and decodes the media streams for synchronized formatting and communicates the synchronized media streams to multimedia devices 422, 424, and 426. Consequently, each of the multimedia devices 422, 424, and 426 receive the same synchronized media stream having the same audio format.

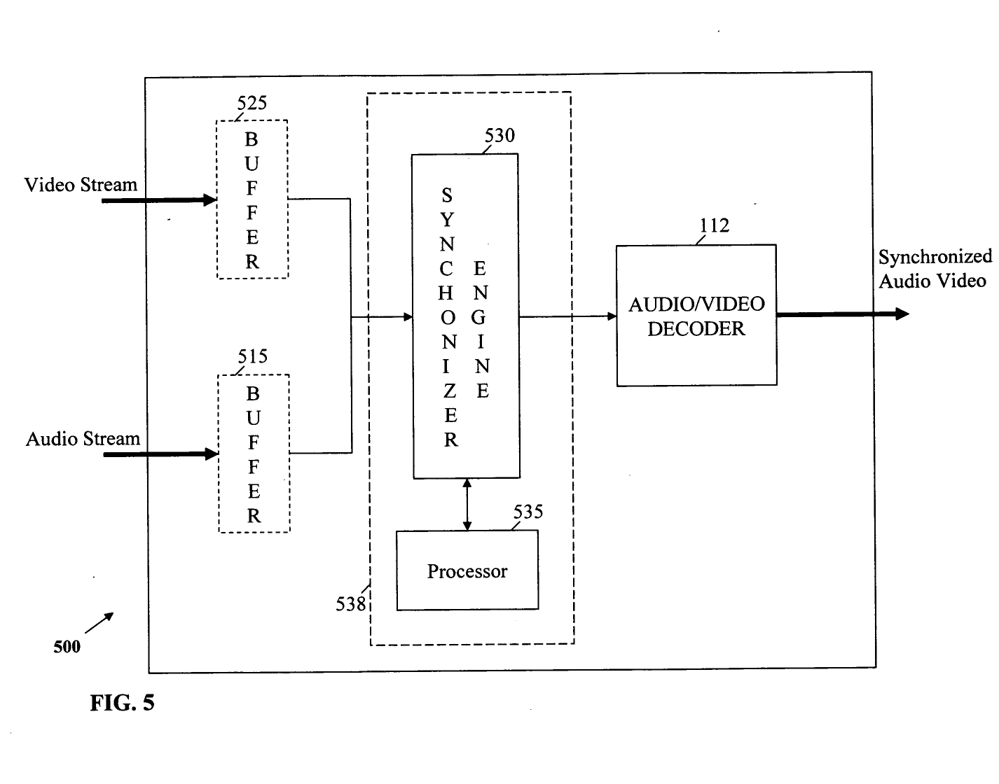

FIG. 5 is a block diagram of exemplary components of an AV synchronizer 500. The AV synchronizer 500 is configured to receive at least one buffered video stream 525 and at least one buffered audio stream 515 of data packets to a synchronization engine 520 that decodes the video packets and decodes the audio packets of the selected audio stream to accumulate video and audio data for an integrated audio/video (AV) frame interval associated with a matched time slot and outputs this accumulated data to an audio/video decoder 112. The audio decoder 112 combines the video and audio frames to output a synchronized audio/video frame for delivery to the multimedia device 110 to present. Further, a processor 535 may control synchronization and interface with the synchronizer engine 530. According to exemplary embodiments, the processor 535 and the synchronizer engine 530 may be stand alone components or may be an integrated component 538. In an exemplary embodiment, the video stream 525 includes video data having a time-slot and/or another sequence identifier and the audio stream 515 includes audio data of a selected audio format associated with the video stream 525. The associated audio stream 515 also includes a time-slot or another sequence identifier that is matched or otherwise correlated with the video data so that the audio stream 515 and the video stream 525 may be integrated for a synchronized frame of audio video (AV) data.

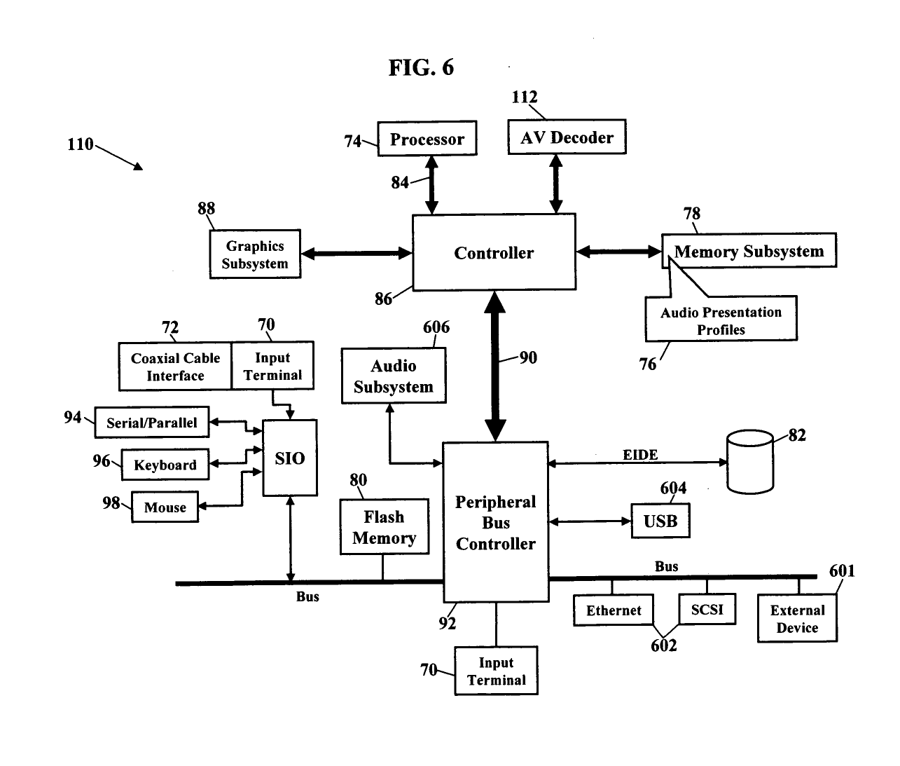

FIG. 6 is a block diagram of exemplary details of the multimedia device 110. The multimedia device 110 can be any device, such as an analog/digital recorder, television, CD/DVD player/recorder, audio equipment, receiver, tuner, and/or any other consumer electronic device. The multimedia device 110 may also include any computer, peripheral device, camera, modem, storage device, telephone, personal digital assistant, and/or mobile phone. The multimedia device 110 may also be configured as a set-top box (“STB”) receiver that receives and decodes digital signals.

The multimedia device 110, in fact, can be any electronic/electrical device that has an input for receiving the streams of selected audio format and/or the video stream. The input may include a coaxial cable interface 72 for receiving signals via a coaxial cable (not shown). The input may additionally or alternatively include an interface to a fiber optic line, to a telephone or data line (such as an RJ-11 or RJ-45), to other wiring, and to any male/female coupling. Further input/output combinations include wireless signaling such as Bluetooth, IEEE 802.11, or infrared optical signaling.

The multimedia device 110 includes one or more processors 74 executing instructions stored in a system memory device. The instructions, for example, are shown residing in a memory subsystem 78. The instructions, however, could also reside in flash memory 80 or a peripheral storage device 82. The one or more processors 74 may also execute an operating system that controls the internal functions of the multimedia device 110.

A bus 84 may communicate signals, such as data signals, control signals, and address signals, between the processor 74 and a controller 86. The controller 86 provides a bridging function between the one or more processors 74, any graphics subsystem 88 (if desired), the memory subsystem 78, and, if needed, a peripheral bus 90. The peripheral bus 90 may be controlled by the controller 86, or the peripheral bus 90 may have a separate peripheral bus controller 92. The peripheral bus controller 92 serves as an input/output hub for various ports. These ports include an input terminal 70 and perhaps at least one output terminal. The ports may also include a serial and/or parallel port 94, a keyboard port 96, and a mouse port 98. The ports may also include networking ports 402 (such as SCSI or Ethernet), a USB port 404, and/or a port that couples, connects, or otherwise communicates with an external device 401 which may be incorporated as part of the multimedia device 110 itself or which may be a separate, stand-alone device.

The multimedia device 110 may also include an integrated audio subsystem 406 (or, alternatively a peripheral audio subsystem (not shown)), which may, for example, produce sound through an embedded speaker in a set-top box, and/or through the audio system of a television. The multimedia device 110 may also include a display device (i.e., LED, LCD, plasma, and other display devices) to present instructions, messages, tutorials, and other information to the user/subscriber using an embedded display. Alternatively, such instructions may be presented using the screen of a television or other display device. The multimedia device 110 may further include one or more encoders, one or more serial or parallel ports 94, input/output control, logic, one or more receivers/transmitters/transceivers, one or more clock generators, one or more Ethernet/LAN interfaces, one or more analog-to-digital converters, one or more digital-to-analog converters, one or more “Firewire” interfaces, one or more modem interfaces, and/or one or more PCMCIA interfaces. Those of ordinary skill in the art understand that the program, processes, methods, and systems described herein are not limited to any particular architecture or hardware. For example, the multimedia device 110 may be implemented as a system-on-a-chip or system on chip (SoC or SOC) that integrates all components into a single integrated circuit (i.e., the chip). Alternatively, the multimedia device 110 may be implemented as a system in package (SiP) comprising a number of chips in a single package.

The processor 74 may be implemented with a digital signal processor (DSP) and/or a microprocessor. Advanced Micro Devices, Inc., for example, manufactures a full line of microprocessors (Advanced Micro Devices, Inc., One AMD Place, P.O. Box 3453, Sunnyvale, Calif. 94088-3453, 408.732.2400, 800.538.8450, www.amd.com). The Intel Corporation also manufactures a family of microprocessors (Intel Corporation, 2200 Mission College Blvd., Santa Clara, Calif. 95052-8119, 408.765.8080, www.intel.com). Other manufacturers also offer microprocessors. Such other manufacturers include Motorola, Inc. (1303 East Algonquin Road, P.O. Box A3309 Schaumburg, Ill. 60196, www.Motorola.com), International Business Machines Corp. (New Orchard Road, Armonk, N.Y. 10504, (914) 499-1900, www.ibm.com), and Transmeta Corp. (3940 Freedom Circle, Santa Clara, Calif. 95054, www.transmeta.com). Texas Instruments offers a wide variety of digital signal processors (Texas Instruments, Incorporated, P.O. Box 660199, Dallas, Tex. 75266-0199, Phone: 972-995-2011, www.ti.com) as well as Motorola (Motorola, Incorporated, 1303 E. Algonquin Road, Schaumburg, Ill. 60196, Phone 847-576-5000, www.motorola.com). There are, in fact, many manufacturers and designers of digital signal processors, microprocessors, controllers, and other components that are described in this patent. Those of ordinary skill in the art understand that this components may be implemented using any suitable design, architecture, and manufacture. Those of ordinary skill in the art, then understand that the exemplary embodiments are not limited to any particular manufacturer's component, or architecture, or manufacture.

The memory, shown as memory subsystem 78, flash memory 80, or peripheral storage device 82, may also contain an application program. The application program cooperates with the operating system and with a visual display device to provide a Graphical User Interface (GUI). The graphical user interface provides a convenient visual and/or audible interface with a user of the multimedia device 110. For example, a subscriber or authorized user, may access a GUI for selecting an audio format, such as an English DOLBY® 5.1 audio format. That is, the user/subscriber may select or otherwise configure an audio profile contained within a local database 76 or a remote database (e.g., a VHO component storing subscriber/customer profiles) of user instructions/preferences such that the multimedia device 110 consults the database to access the audio profile and such that the audio profile provides instructions for automatically selected the audio format of the audio stream to conserve bandwidth. Still further, if the audio profile is used to automatically select an audio format, then the multimedia device 110 may provide an alert or other notification to the user of the selected audio format.

FIG. 7 illustrates yet another operating environment 700 for multicast data streaming according to some of the exemplary embodiments. Here, the communications network 108 communicates with a residential gateway 710 having the AV decoder 112 that may be stand alone or be integrated as a residential gateway/AV decoder (RG/AV decoder) 720. The residential gateway 710, via the integrated AV decoder 112, detects, decodes, and deciphers the video stream and the matched audio stream to generate the integrated audio video frames to the multimedia device 110.

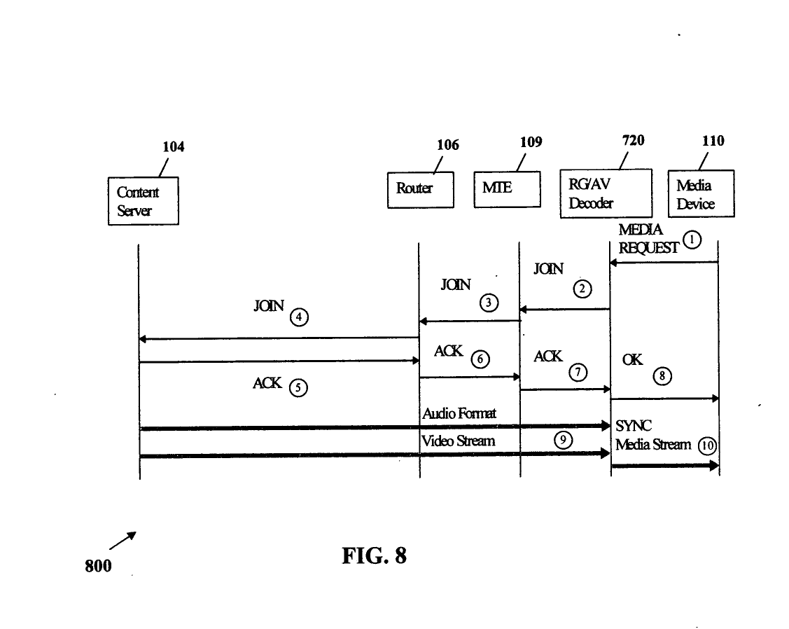

FIG. 8 is a schematic illustrating another exemplary multicast media session 800 according to some of the embodiments. Here the RG/AV decoder 720 knows the source for the multicast media session, and the customer/subscriber is authorized to access this media source. When the customer/subscriber desires a session, the multimedia device 110 communicates the media request. The RG/AV decoder 720 receives and inspects the media request and determines that the media request is associated with an authorized multicast source. Thereafter, the RG/AV decoder 720 generates a command to access the media source, such as, for example, by generating an Internet Group Management Protocol (IGMP) join (shown as “JOIN” in the figures) that is communicated to the DSLAM 109. The DSLAM 109 receives and forwards the IGMP join to one or more routers 106. Various routers 106 within the communications network 108 route the IGMP join to an appropriate multicast source. The IGMP may be used symmetrically or asymmetrically, such as asymmetric protocol used between multicast routers 106.

Thereafter, the content source 104 (here, the multicast source) responds with an acknowledgment, such as, for example, an IGNP acknowledgement (referred to as “ACK” in the figures) or similar message indicating the command to access the content source looks like a reasonable request and that the content can be supplied. The IGMP acknowledgement is communicated to the router, from the router to the DSLAM 109, then from the DSLAM 109 to the RG/AV decoder 720. The RG/AV decoder 720 converts the acknowledgment to an “OK” formatted for the multimedia device 110 and forwards the “OK” to the multimedia device 110. The requested multicast media streams then communicate as a video stream and an audio stream (having the selected format and language preference) from the appropriate multicast content source 104 to the RG/AV decoder 720. The RG/AV decoder 720 decodes and synchronizes the audio video stream and forwards the synchronized media stream to the multimedia device 110.

According to some of the exemplary embodiments, the residential gateway 710 converts the SIP invite from the multimedia device 110 of the customer's IP address space to the IGMP join to a public address space and, similarly, converts the IGMP acknowledgement response from the public base to the SIP “OK” to the multimedia device 110 of the customer's IP address space. Under these circumstances the RG/AV decoder 720 typically performs NAT (Network Address Translation) and/or a PAT (Port Address Translation) functions. The multicast source sees the network address of the RG/AV decoder 720—not the multimedia device 110. The RG/AV decoder 720 uses different port numbers to keep track of the transactions that belong to the multimedia device 110 as opposed to message flow related to another communications device in the customer's IP address space network.

Further exemplary embodiments allow the RG/AV decoder 720 to inspect the IGMP join and IGMP acknowledgement response. Because the RG/AV decoder 720 can inspect, the RG/AV decoder 720 knows the port assignments and can configure itself to receive the media stream. When the media stream terminates, the RG/AV decoder 720 needs to know what port number is assigned to the multimedia device 110. By inspecting the IGMP join and IGMP acknowledgement response the RG/AV decoder 720 can self-configure for the dynamic port assignment. So, generally, that sort of function would be considered as a SIP application layer gateway associated with the NAT/PAT function. The multicast source selects the port to which it sends the media stream and associates that media stream with that particular IGMP join converted from the SIP invite of the multimedia device 110. The RG/AV decoder 720 needs to be aware of the IGMP protocol in order to understand into what port the media stream is coming and that the media stream is coming in response to some request from inside the private network.

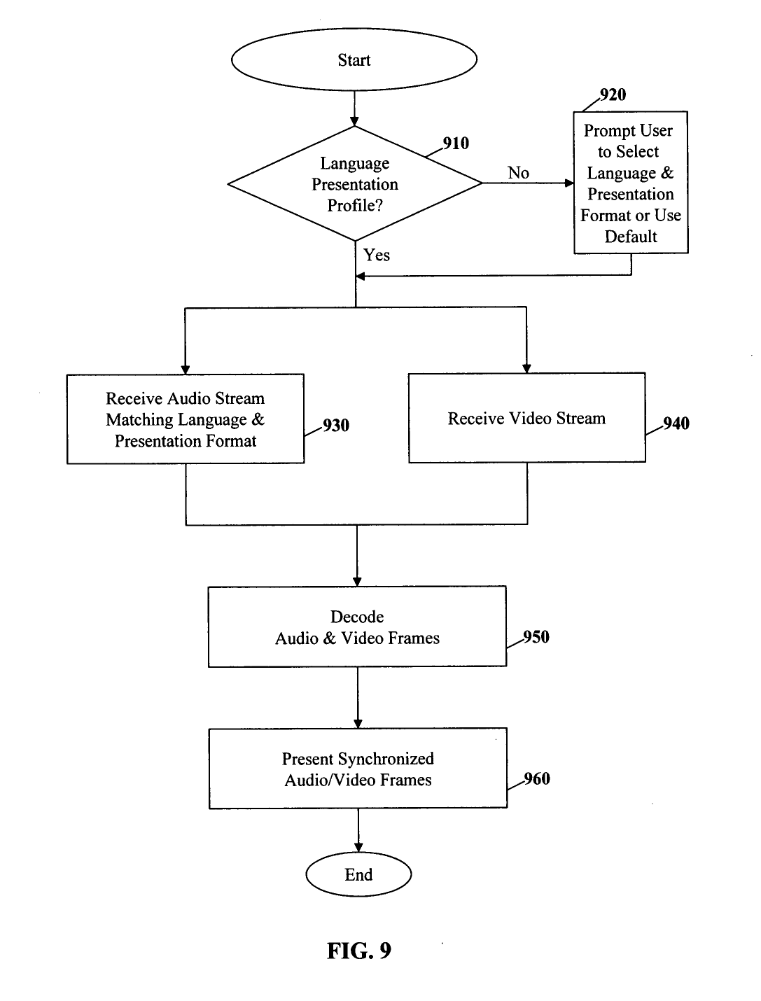

FIG. 9 illustrates a flow chart for synchronizing audio data and video data according to some of the embodiments. The method begins with a query to determine if there is an audio presentation profile for selecting an audio stream [block 910]. If not, then a user interface of a multimedia device prompts the user for selection of an audio format and language preference [block 920]. Thereafter, the method continues with blocks 930 and 940 to receive the audio stream matching the audio format and language preference and the corresponding video stream. Thereafter, the audio stream and the video stream are decoded [block 950] and output as a synchronized audio video frame for presentation [block 960] and/or for further processing by a multicast system, such as, for example, presentation to a multimedia device.

According to an exemplary embodiment, a video stream of data that includes a video streaming protocol, such as a time slot, reference frame, or other sequence identifier, and an audio stream of data that includes an audio streaming protocol, such as a time slot, reference frame, or other sequence identifier (e.g., a packet header) are received and decoded to correlate matching time slots, reference frame, or sequence identifiers such that a synchronized audio/video (AV) stream of data is created. Each time slot may include a time-stamp and a sequence identifier that provides integration information for combining the video stream of data and the audio stream of data. Moreover, the audio stream of data may be selected according to an audio presentation profile associated with a multimedia device or according to an interactive selection of a presentation format identified by a user of the multimedia device. The video stream and audio stream may be synchronized by a communications network component, residential gateway component, a set-top box component, a multimedia device component, and or a combination of these components.

While several exemplary implementations of embodiments of this invention are described herein, various modifications and alternate embodiments will occur to those of ordinary skill in the art. Accordingly, this invention is intended to include those other variations, modifications, and alternate embodiments that adhere to the spirit and scope of this invention.

What is claimed:

1. A multimedia device comprising:
a video buffer for accumulating a decoded video stream for at least one frame interval and for outputting a frame of the decoded video stream for each frame interval, the decoded video stream comprising at least one video time slot;
an audio buffer for accumulating a decoded audio stream for at least one frame interval and for outputting a frame of the decoded audio stream for each frame interval, the decoded audio stream having a selected audio presentation format, the decoded audio stream further comprising at least one audio time slot matching the at least one video time slot of the decoded video stream; and
synchronization means to integrate each frame of the decoded video stream and each of the decoded audio stream so as to generate synchronized frames of audio video data,
wherein the audio presentation profile comprises a selected audio format and a selected language from a plurality of available audio formats and languages such that audio formats and languages other than the selected audio format and selected language are not included in the encoded multicast protocol audio stream.

2. The multimedia device of claim 1, the audio stream comprising a real-time protocol (RTP) audio stream.

3. The multimedia device of claim 1, the video stream comprising a real-time protocol (RTP) video stream.

4. The multimedia device of claim 1, the synchronization means comprising a synchronizer engine and a processor to control the decoding and synchronization of the audio stream and the video stream.

5. The multimedia device of claim 1, the video decoder comprising one of an MPEG decoder, H.263 decoder, and H.264 decoder.

6. The multimedia device of claim 1, the audio decoder comprising one of an MPEG decoder, H.263 decoder, and H.264 decoder.

7. The multimedia device of claim 1, further comprising:
a transmitter to output the synchronized frame of audio video data to a multimedia presentation device.

8. The multimedia device of claim 1, further comprising:
presentation means for presenting the synchronized frame of audio video data.

9. The multimedia device of claim 1, further comprising:
a receiver for receiving the encoded multicast protocol video stream of data; and
a receiver for receiving the encoded multicast protocol audio stream of data matching the audio presentation profile.

10. A method for synchronizing a multicast data stream, comprising:
receiving, decoding, and deciphering a video stream of data comprising at least one time slot having at least one packet header, the at least one packet header comprising a time-stamp and a sequence identifier associated with each time slot;
receiving, decoding, and deciphering an audio stream of data matching an audio presentation profile, the audio stream comprising at least one time slot matching the at least one time slot of the multicast video stream;
accumulating the decoded video stream for at least one frame interval and for outputting a frame of video data for each frame interval;
accumulating the decoded audio stream for at least one frame interval and for outputting a frame of audio data for each frame interval; and
synchronizing the frame of video data and the frame of audio data to generate a synchronized frame of audio video data,
wherein the audio presentation profile comprises a selected audio format and a selected language preference such that undesirable audio formats and undesirable languages are filtered from the audio stream to conserve bandwidth.

11. The method of claim 10, the audio stream comprising a real-time protocol (RTP) audio stream.

12. The method of claim 10, the video stream comprising a real-time protocol (RTP) video stream.

13. The method of claim 10, further comprising:
communicating the synchronized frame of audio video data to a multimedia presentation device.

14. The method of claim 10, further comprising:
presenting the synchronized frame of audio video data.

15. A storage medium on which is encoded instructions for performing a method for synchronizing a multicast data stream, the method comprising:
receiving, decoding, and deciphering a video stream of data comprising at least one time slot having at least one packet header, the at least one packet header comprising a time-stamp and a sequence identifier associated with each time slot;
receiving, decoding, and deciphering an audio stream of data matching an audio presentation profile, the audio stream comprising at least one time slot matching the at least one time slot of the multicast video stream;
accumulating the decoded video stream for at least one frame interval and for outputting a frame of video data for each frame interval;
accumulating the decoded audio stream for at least one frame interval and for outputting a frame of audio data for each frame interval; and
synchronizing the frame of video data and the frame of audio data to generate a synchronized frame of audio video data, wherein the audio presentation profile comprises a selected audio format and a selected language preference such that undesirable audio formats and undesirable languages are filtered from the audio stream to conserve bandwidth.

16. The storage medium of claim 15, wherein the audio stream comprises a real-time protocol (RTP) audio stream.

17. The storage medium of claim 15, wherein the video stream comprises a real-time protocol (RTP) video stream.

18. The storage medium of claim 15, further comprising instructions for:
communicating the synchronized frame of audio video data to a multimedia presentation device.

19. The storage medium of claim 15, further comprising instructions for:
presenting the synchronized frame of audio video data.
